(19) United States
(12) Patent Application Publication
(10) Pub. No.: US 2003/0055900 A1
(43) Pub. Date: Mar. 20, 2003

(54) Network and associated network subscriber having message route management between a microprocessor interface and ports of the network subscriber

(75) Inventors: Karl Glas, Herzogenaurach (DE); Dieter Klotz, Fuerth (DE); Christoph Muench, Eggenstein (DE)

Correspondence Address: SUGHRUE MION, PLLC, 2100 Pennsylvania, NW, Washington, DC, 20037-3213, US

(73) Assignee: SIEMENS AKTIENGESELLSCHAFT

(21) Appl. No.: 10/210,111

(22) Filed: Aug. 2, 2002

Related U.S. Application Data
(63) Continuation of application No. PCT/DE01/00415, filed on Feb. 2, 2001.
(63) Continuation of application No. PCT/DE01/00414, filed on Feb. 2, 2001.

(30) Foreign Application Priority Data
Feb. 2, 2000 (DE) 100 04 432.8
Feb. 2, 2000 (DE) 100 04 426.3

(51) Int. Cl. G06F 15/173; G06F 15/16

(52) U.S. Cl. 709/205; 709/238

(57) ABSTRACT

A network has redundancy features and includes at least two series constructed of a number of network subscribers (100 . . . 107; 110 . . . 117). The at least two series are connected to one another via at least two communication channels, of which only the first one is active and the second one is deactivated. The communication channels are realized by connecting ports of the network subscribers. A network subscriber of the second communication channel monitors the first communication channel for interruption and places the second communication channel into the active state if the first communication channel is interrupted. The network subscribers have several ports, to which further network components can be connected. A microprocessor interface (25) connects the ports (28 . . . 31) with a user-internal processor bus. A switch control (46) provides message route management between the ports (28 . . . 31) and the microprocessor interface (25).

This is a Continuing Application of International Application PCT/DE01/00415, with an international filing date of Feb. 2, 2001, which was published under PCT Article 21(2) in German, and the disclosure of which is incorporated into this application by reference. This is additionally a Continuing Application of International Application PCT/DE01/00414, with an international filing date of Feb. 2, 2001, which was also published under PCT Article 21(2) in German, and the disclosure of which is also incorporated into this application by reference.

### FIELD OF AND BACKGROUND OF THE INVENTION

The present invention relates to a network and to a network subscriber, particularly a field device, for such a network. The invention further relates to a network subscriber, particularly a field device, and to a network in which a plurality of such network subscribers is interconnected.

Such a network is known from the Siemens publication entitled “Industrial Ethernet with Switching and Fast Ethernet Technology,” Basic Information 10/98, Order No. 6ZB5530-1AH02-0BA0. This document describes a so-called optical switch module (OSM) with a plurality of ports for connecting additional network components. As an example, to construct an Ethernet or Fast Ethernet network, terminals are connected to the ports and are thus interlinked via the OSM. A plurality of OSMs can be connected in series in a linear structure. An optical ring is created if the two line ends are connected to an optical redundancy manager (ORM). Test messages or test telegrams that the ORM feeds into the two line ends are used to check whether there is an interruption within the series of OSMs. If there is no error, i.e., if the series is not interrupted, the ORM disconnects the two line ends. If there is an error, the two line ends are interconnected by the ORM. The cited publication further describes a network that comprises a plurality of such series, each of which is connected via an ORM to form a closed optical ring. Two optical rings are interconnected via two OSMs. The two OSMs interposed between the optical rings each form a communication channel, one of which is active and the other one is in standby mode. The two OSMs exchange their status information via special standby ports, which are connected by cables. If the connection via the active OSM fails, the redundant OSM releases its communication channel, i.e., it switches from standby mode into active mode. In this manner a comparatively short reconfiguration time is achieved. This prevents physical faults or errors, transient electromagnetic interference, network expansions, or the replacement of components from affecting the communication between the network components. The drawback is that two additional devices are required for the redundant connection of two optical rings, which must furthermore be interconnected by cables.

Siemens publication entitled “Industrial Ethernet with Switching and Fast Ethernet Technology,” Basic Information 10/98, Order No. 6ZB5530-1AH02-0BA0, describes a network subscriber, a so-called Optical Switch Module (OSM), with a plurality of ports for connecting additional network components. As an example, to construct an Ethernet or Fast Ethernet network, terminals are connected to the ports and are thus interlinked via the OSM. This creates a star-shaped network topology. The OSM is a so-called layer-2 component, which analyses the destination address and the source address of the circulating messages or telegrams and forwards the messages or telegrams according to their addresses via the ports, i.e. it performs message or telegram route management. This achieves a decoupling of the individual communication channels and makes available the full transmission capacity for each communication channel.

Networks based on star-shaped structures are widely known in the field of office communication. In automation systems, the Ethernet is frequently used for communication on the management level and the cell level. On the field level, however, the Ethernet has found practically no acceptance. On the field level, field buses are used, e.g. PROFIBUS, which have a bus structure, i.e., the network subscribers are linearly interconnected. Communication on the field level thus takes place with a different physical structure or different physics and different protocol from that on the cell or the management level. For the vertical data traffic across the boundaries between the individual levels, so-called gateway components must be used. This has drawbacks, such as low speed in vertical direction, absence of data transparency, and high software and maintenance costs of the automation system. In addition, better performance on the field level as compared to the current field busses is desirable. These drawbacks are further aggravated as the vertical data traffic in automation systems continues to increase due to operational data acquisition, alarm management, visualization, and remote maintenance.

The publication entitled “Das Netz ist die Steuerung” [The Network is the Control System”] by Martin Buchwitz and Martin Jetter, published in Elektronik 8/1999, pp. 38 to 56, describes a control system for use in automation technology which has a switch with a plurality of ports. The individual components of the control system are connected to the switch via a Fast Ethernet Interface and can communicate with one another via the switch. Field devices, however, continue to be radially linked to the outbound ports of the control system or to an external switch, i.e., the field devices are linked to the outbound ports of the control system or to an external switch in the form of a star.

### OBJECTS OF THE INVENTION

One object of the invention is to provide a network with redundancy features, which is distinguished by a short reconfiguration time and is low in cost. Another object of the invention is to provide a network subscriber and a network, which are simple to configure for communication and which are low in cost.

### SUMMARY OF THE INVENTION

According to one formulation of the present invention, the above and other objects are achieved a network that has redundancy features and that includes a plurality of network subscribers that have ports and that form at least a first series and a second series of network subscribers. Therein, a first communication channel and a second communication channel interconnect the first series and the second series of network subscribers, wherein the first communication channel is in an active state and the second communication channel is initially in an inactive state. The first communication channel is formed by a connection between a respective port of a first network subscriber of the plurality of network subscribers and a respective port of a second network subscriber of the plurality of network subscribers, wherein the first network subscriber is arranged in the first series of network subscribers, and wherein the second network subscriber is arranged in the second series of network subscribers. The second communication channel is formed by a connection between a respective port of a third network subscriber and a respective port of a fourth network subscriber, wherein the third network subscriber is arranged in the first series of network subscribers, and wherein the fourth network subscriber is arranged in the second series of network subscribers. If the first communication channel is not interrupted, the first network subscriber cyclically transmits port-select-messages to other network subscribers of the plurality of network subscribers that are arranged in the first series of network subscribers. The third network subscriber evaluates the port-select-messages to monitor the first communication channel for interruption. If the first communication channel is interrupted, the third network subscriber switches the second communication channel from the inactive state to the active state.

According to another formulation of the present invention, the above and other objects are achieved by a network subscriber of an automation system, wherein the network subscriber has a plurality of ports, to which additional network components are connected. The network subscriber also has a network-subscriber-internal processor bus and a microprocessor interface to connect the plurality of ports with the network-subscriber-internal processor bus. Finally, the network subscriber includes a switch control to route messages between the plurality of ports and the microprocessor interface.

According to yet another formulation of the present invention, the above and other objects are achieved a network including a plurality of field devices that are configured as a plurality of network subscribers, wherein the network subscribers are interconnected in a linear network topology. Each network subscriber has a plurality of ports, to which additional network components are connected; a network-subscriber-internal processor bus; a microprocessor interface to connect the plurality of ports with the network-subscriber-internal processor bus; and a switch control to route messages between the plurality of ports and the microprocessor interface.

The invention has the advantage that the coupling of two series requires no additional devices. The network can thus be implemented substantially more cost-effectively.

The redundant configuration of the communication channel between two series requires no additional hardware, especially cables, if the third network subscriber, to monitor the first communication channel, evaluates messages or telegrams, so-called port-select-messages or port-select-telegrams, which the first network subscriber transmits cyclically to the network subscribers arranged in the first series, when the communication channel is uninterrupted.

Advantageously, the maximum number of devices involved in message traffic across different series can be kept low by activating that communication channel out of two available communication channels that is formed by connecting a port of a network subscriber arranged in the first series at the shortest distance from the center of the first series with a port of a network subscriber arranged in the second series. Any conflict that may arise if two network subscribers are equidistant can simply be resolved by device-address-based prioritization, e.g., by giving preference to the network subscriber with the shorter device address.

A network is distinguished by substantial freedom regarding subscriber interconnection. Three-dimensional structures can also be implemented. For this purpose, the first series is connected with a third series via at least a third communication channel, for example. The second series is connected to the third series either directly or indirectly via a communication path that does not lead through network subscribers of the first series, so that a loop would exist if all communication channels of the network were in their active state. At the same time, the network subscribers of the network are configured in such a way that, by exchanging configuration messages, they ensure that the network is loop-free with respect to communication. In addition, each network subscriber is connected with every other network subscriber via exactly one active communication path, i.e., via a communication path that includes only active communication channels. Since the redundant transmission paths that exist in the presence of loops are managed by configuration messages, no additional management hardware is required.

To make the network loop-free, the time-tested algorithm of the spanning tree method can advantageously be used. Each series is considered a virtual network subscriber and each available port of a network subscriber of a series, whose connection with an available port of a network subscriber of a different series forms an available communication channel, is considered an available port of the virtual network subscriber.

If the two line ends of a series are interconnected by a network subscriber, a ring-shaped network topology is obtained. The network subscriber at one line end has the function of a redundancy manager, which is configured to disconnect the two line ends in the absence of an error, i.e., if there is no interruption within the series, and to connect the two line ends if an error is present. This advantageously permits quick error correction within the series and thus increases the availability of the network. Such a redundant ring, which, at any time during operation, has a linear network topology with respect to communication, is also referred to as a series since it is distinguished from a series only with respect to the redundancy.

Network subscribers, particularly field devices, with four ports for connecting additional network components, and with an interface—a so-called microprocessor interface—for connecting the ports with a user-internal processor bus, and with a control unit—a so-called switch control—for message route management between the ports and the microprocessor interface have the advantage that they can be interconnected in the line structure familiar to the user of field buses. A separate switch, which would be required in a star-shaped structure, is unnecessary. Particularly in a network according to the Ethernet, Fast Ethernet or Gigabit Ethernet specification, the invention enables the construction of a large-sized network because only the distance between two network components may not exceed certain limits, while the length of the linear structure is unlimited. In addition, the integration of switch functions into the network subscribers has the advantage that, particularly in an Ethernet, CSMA/CD access control can be deactivated and the network obtains a deterministic behavior. Thus the application range of the network subscribers and the network is expanded to include application cases in which real time behavior is required. Four ports are provided on the network subscribers for connecting additional network components. Users can be interconnected to form a two- or three-dimensional network structure since two ports thereof can be used for linking the network subscribers into a line and two additional ports for connecting this line with another line.

Configuring the interfaces, which are realized by the ports, according to the Ethernet or Fast Ethernet specification has the advantage that, in the implementation of for instance a field bus with such network components, existing technological know-how of other areas can be used. This provides a universal network for office, management, cell, and field levels and enables transparent access to any data. Advantageously, a gateway for coupling network areas with different physical structures and different protocols is not required. In addition, networks based on the Ethernet specification are distinguished by their high data transfer capacity. Such networks offer cost advantages because the technology is widely available and components are available in large quantities. A large number of network subscribers can be connected to a network. The invention combines the advantages of the line structure or bus structure of the network, which is preferred in the field area, e.g., the advantage of simple interconnection of the subscribers, with the aforementioned advantages of networks based on the IEEE 802.3 Ethernet specification. The switch functions integrated into the network subscribers assume the function of a network component that was previously separately installed, e.g. a switch, which is thus eliminated.

A further improvement in automation technology applications, particularly in time-critical applications, is obtained if the control unit of the switch function is configured to evaluate a transmission priority of the messages that are to be transmitted and to transmit high priority messages before lower priority message.

A microprocessor for correcting an internal clock by means of clock information received in the messages has the advantage that different network subscribers can execute synchronized actions.

The invention has the advantage that the network subscribers, particularly field devices, can be interconnected in a linear structure, in a manner that the field bus user is familiar with. A separate switch, which would be required in a star-type structure, is unnecessary. Especially in a network according to the Ethernet, Fast Ethernet or Gigabit Ethernet specification, the invention enables the construction of a large network, because only the distance between two network components may not exceed certain limits, while the length of the linear structure is unlimited. In addition, the integration of switch functions into the network subscribers has the advantage that particularly with Ethernet, CSMA/CD access control can be deactivated and the network obtains a deterministic behavior. This expands the field of application of the network subscribers and the network to cases where real-time response is required.

Providing four ports on the network subscribers for connecting additional network components makes it possible to interconnect the users in a two- or three-dimensional network structure, since two ports each can be used to link the network subscriber into a line and two additional ports each to connect the line with another line.

With such network subscribers, as explained above, a network topology with a linear arrangement of the users can be created in a simple manner. If the two line ends are interconnected by a network subscriber, a ring-shaped network topology is obtained. The network subscriber at one line end has the function of a redundancy manager, which is configured to disconnect the two line ends in the absence of an error, i.e. if there is no interruption within the series, and to connect the two line ends if an error is present. This advantageously permits quick error correction within the series and thus increases the availability of the network. Such a redundant ring, which at any time of operation has a linear network topology with respect to communication, will hereinafter also be referred to as a series since it is distinguished from a series only with respect to the redundancy.

A communication channel between two series formed by a plurality of network subscribers can be redundantly configured. For this purpose, a first communication channel is simply formed by connecting a port of a first network subscriber, which is arranged in the first series, with a port of a second network subscriber, which is arranged in the second series. Furthermore, a second communication channel is realized by connecting a port of a third network subscriber, which is again arranged in the first series, with a port of a fourth network subscriber in the second series. The third network subscriber can monitor the first communication channel for possible interruption and can activate the second communication channel if the first communication channel is interrupted. This provides a redundant configuration of the communication channels between series with little complexity. This type of redundancy can be implemented cost-effectively and is distinguished by a short reconfiguration time.

The redundant configuration of the communication channel between two series requires no additional hardware, especially cables, if the third network subscriber, to monitor the first communication channel, evaluates messages, so-called port select messages, that the first network subscriber transmits cyclically to the network subscribers arranged in the first series when the communication channel is uninterrupted.

Advantageously, the maximum number of devices that must be cycled through for cross-series message traffic can be kept low by activating that communication channel out of two available communication channels which is formed by connecting a port of a network subscriber arranged in the first series at the shortest distance from the center of the series with a port of a network subscriber arranged in the second series. Any conflict that may arise if two network subscribers are equidistant can simply be resolved by device-address-based prioritization, e.g. by giving preference to the network subscriber with the shorter device address.

The network subscribers and a network constructed with such network subscribers are distinguished by substantial freedom regarding user interconnection. Three-dimensional structures can also be implemented. For this purpose, for instance, the first series is connected with a third series via at least a third communication channel. The second series is connected to the third series either directly or indirectly via a communication path that does not lead through network subscribers of the first series, so that a loop would exist if all communication channels of the network were in their active state. At the same time, the network subscribers of the network are configured in such a way that by exchanging configuration messages they ensure that the network is loop-free with respect to communication and each network subscriber is connected with every other network subscriber via exactly one active communication path, i.e. a communication path that includes only active communication channels. Since the redundant transmission paths that exist in the presence of loops are managed by configuration messages, no additional management hardware is required.

To make the network loop-free, the time-tested algorithm of the spanning tree method can advantageously be used. Each series is considered a virtual network subscriber and each available and potentially active port of a network subscriber of a series, whose connection with an available port of a network subscriber of a different series forms an available communication channel, is considered an available port of the virtual network subscriber.

Furthermore, the clock of the network subscribers can advantageously be synchronized in a network. For this purpose, a first network subscriber sends a first message containing the clock time of the first network subscriber corrected by a transmit time delay to a second network subscriber. The second user stores the message runtime over the physical transmission link between the first network subscriber and the second network subscriber. This message runtime can, for instance, be entered manually or measured in advance by additional message traffic. The second network subscriber measures the time delay since the receipt of the first message and corrects the clock time received in the first message by the runtime and a measured receive time delay. The second network subscriber is thus advantageously able at any time to determine a synchronized clock time from the sum of the clock time received in the first message and the receive time delay to which the runtime is added. Variable transmit and receive time delays do not affect the result of the synchronization.

If the second network subscriber is furthermore configured to send to a third network subscriber a second clock synchronization message containing a received clock time that is corrected by the runtime and the delay time between receiving the first message and transmitting the second message, an iterative forwarding of the respectively corrected clock time from network subscriber to network subscriber is made possible. Identical correction mechanisms can be used in the receiving network subscribers. The runtime stored in each network subscriber corresponds to the runtime over the physical transmission link between the respectively last transmitting and receiving network subscriber.

As an alternative to sending a clock synchronization message from a first to a second network subscriber, the clock may also be synchronized by two messages. For this purpose, the first network subscriber sends a first clock synchronization message to a second network subscriber and simultaneously stores a clock time of the first network subscriber that is corrected by the transmit time delay. The second network subscriber stores the runtime of the message over the physical transmission link between the first network subscriber and the second network subscriber. The second network subscriber measures the time delay since receiving the first message but without stopping the timer used for this purpose. The first network subscriber now sends to the second network subscriber a second message containing the clock time of the first network subscriber corrected by the transmit time delay. The second network subscriber corrects the clock time received in the second message by the runtime and the receive time delay, which is measured in relation to the receipt of the first message. This method with two messages has the same advantages as the clock synchronization method with a single message.

For a network with more than two network subscribers, the method with two messages can likewise be continued in an iterative process. For this purpose the second network subscriber forwards the first message to a third network subscriber and measures the delay time of message forwarding. In a third message, the second network subscriber sends a received clock time corrected by the runtime and the delay time of the first message forwarding to the third network subscriber.

The respective actual transmit time delay is advantageously taken into account in clock synchronization. For this purpose, the first network subscriber has a first timer to determine the transmit time delay, which it starts when entering a message into a list of transmit jobs and which it reads as the value of the transmit time delay after making the message available for physical transmission. The clock time of the message entry must be corrected by that value.

Likewise, the respective actual receive time delay is advantageously taken into account in the transmission. For this purpose, the second network subscriber has a second timer for determining the receive time delay, which it starts when it receives a first message from a physical transmission link.

The runtime of the messages over the physical transmission link between the first network subscriber and the second network subscriber can be stored as a start value in the second timer prior to starting this timer. This has the advantage that the sum of the runtime and the receive time delay can be determined by a single timer.

In a further development, the start and the end of the runtime of a message can be defined, respectively, as the instant at which a characteristic field of a message at a fixed distance from the start of the message leaves a medium independent interface of the first network subscriber or arrives at a medium independent interface of the second network subscriber. Advantageously, measurements of the transmit time delay, the runtime, and the receive time delay are independent from the length of the respective message.

If the network components satisfy the Ethernet, Fast Ethernet or Gigabit Ethernet specification, the type field can advantageously be used as the characteristic field of the message. Upon receipt of the type field the second network subscriber knows that this is a clock synchronization message and can start the required mechanisms. The data field is located behind the type field and can be changed in the transmitter until the type field is output to the media independent interface. This makes it possible to transmit the clock time corrected by the transmit time delay already in the same message.

The runtime of the message over the physical transmission link can be determined exactly if the first network subscriber sends a first message for determining the runtime to a second network subscriber and starts a response timer after making the message available for physical transmission. After receiving the first message for determining the runtime, the second network subscriber starts a timer to measure the residence time and stops the timer after making available a second message for physical transmission to the first network subscriber. The measured residence time is transmitted to the first network subscriber in the second message for determining the runtime. After receiving the second message from the physical transmission link, the first network subscriber stops the response timer and calculates the runtime of a message over the physical transmission link as half the difference between the measured response time and the residence time in the second network subscriber.

### BRIEF DESCRIPTION OF THE DRAWINGS

The invention as well as embodiments and advantages thereof will now be described in greater detail with reference to exemplary embodiments of the invention depicted in the drawings in which:

FIG. 1 shows a communication structure of an automation system,

FIG. 2 is a block diagram of an interface of a network subscriber,

FIG. 3 is a series connection of network subscribers with linear network topology,

FIG. 4 is a series connection of network subscribers with two communication channels,

FIG. 5 shows a two-dimensional interconnection of network subscribers,

FIG. 6 shows a two-dimensional interconnection with redundant configuration,

FIG. 7 shows a two-dimensional network after redundancy management,

FIG. 8 shows a three-dimensional network after redundancy management,

FIG. 9 shows the principal structure of a message or telegram, and

FIG. 10 shows the structure of a job list.

### DETAILED DESCRIPTION OF THE PREFERRED EMBODIMENTS

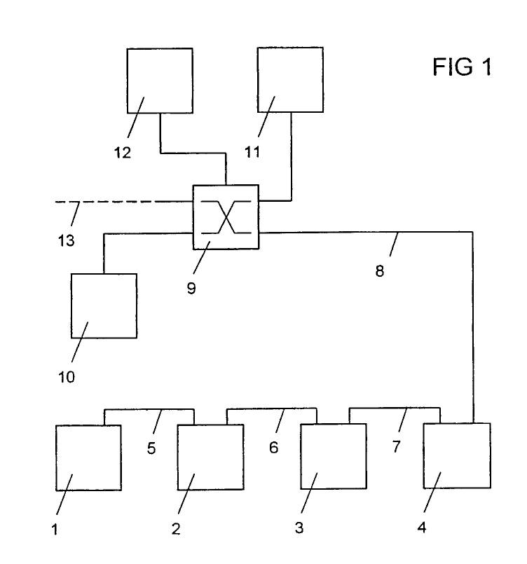

FIG. 1 shows the configuration of a communication structure in an automation system. Communication is effected globally on the management, cell and field level by a network whose data transmission satisfies the IEEE 802.3u Fast Ethernet Standard. On the field level, a sensor 1, e.g. a pressure transducer, a sensor 2, in this case an ultrasonic flow transducer, an actuator 3, a control valve for adjusting a flow, and a programmable controller 4 are interconnected by a bus having twisted pair lines 5, 6 and 7. The programmable controller 4 together with the two sensors 1 and 2 as well as the actuator 3 forms a control loop in which the position of the control valve is defined as a function of the measured values of the pressure transducer and the flow transducer. The programmable controller 4 is connected to a switch 9 by a twisted pair line 8. Also connected with the switch 9 in a star-shaped topology are a cell processor 10, a master processor 11, and a firewall 12 which implements secure Ethernet access. Additional cell processors (not depicted for the sake of clarity) of neighboring cells of the automation system are connected to the switch 9 via a line 13. The preferred embodiment depicted in FIG. 1 clearly illustrates, in particular, the advantage of high data transparency across all levels. For the management, cell and field levels, the same transmission standard is used. The field devices 1, 2 and 3 are interconnected with the programmable controller 4 in a linear topology that is familiar to a person skilled in the art. A further advantage is the universal usability of standard addresses for the individual network subscribers. Address conversion, which would be required on the different levels if different standards were used, is rendered unnecessary in an automation system with the novel network and the novel network subscribers.

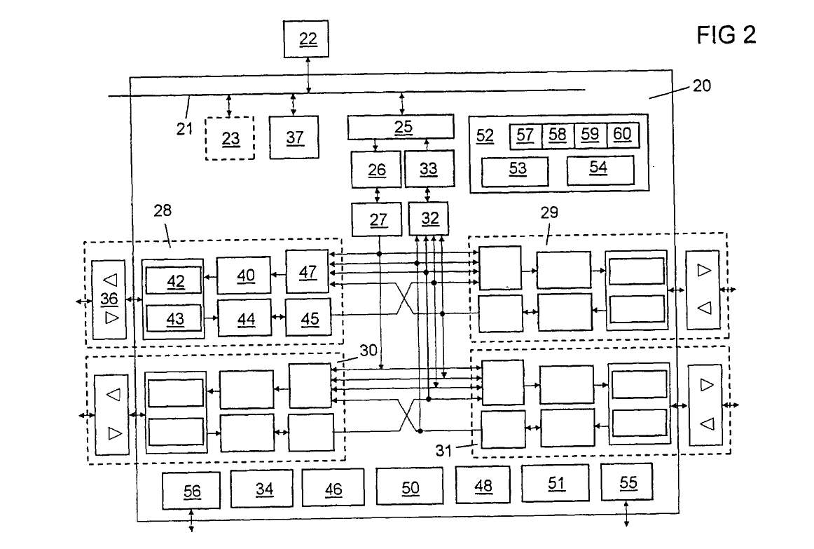

FIG. 2 shows the principal structure of a communication interface of a network subscriber, e.g. the sensor 2 in FIG. 1. Application-specific circuit elements, e.g., a mechanical-electrical transducer element, a device for signal preprocessing, and a voltage supply, are not shown for the sake of clarity. The elements combined in a rectangle 20 can be integrated in an ASIC (Application Specific Integrated Circuit). Communication with the application-specific circuit elements of the network subscriber takes place via a microprocessor bus 21, to which a RAM 22, a microprocessor 23, and a microprocessor interface 25 are connected. The dashed lines in the representation of the microprocessor 23 indicate that integration into the ASIC is optional. Instead, the functions of the microprocessor 23 could be assumed by an external processor. The task of the microprocessor 23 is to execute application programs and perform communication functions, e.g., in the context of the TCP/IP protocol. Another preferred task of the microprocessor 23 is the management of transmit and receive lists of messages or telegrams with different priorities in the external RAM 22. The microprocessor 23 selects a job from a transmit list in the external RAM 22 and starts or activates a DMA controller 26, referred to as DMA 1 control, via a microprocessor interface 25 after having previously entered into the DMA controller 26 the number of data bytes to be transmitted and a pointer that points to the data byte to be transmitted. When the transmit job has been transferred completely into a transmit buffer 27 by the DMA controller 26, the microprocessor 23 removes this transmit job from the transmit list in the RAM 22 and processes the next transmit job unless the transmit list is empty and provided that there is still room in the memory of the transmit buffer 27.

Also integrated in the ASIC 20 are four Ethernet controllers 28, 29, 30 and 31. Each of these Ethernet controllers enters the data bytes of a completely received message into a receive list in the RAM 22 via a multiplexer 32, a DMA controller 33, also referred to as DMA 2 control, and microprocessor interface 25. The microprocessor 23 accesses the receive list and evaluates the received data according to an application program.

The microprocessor interface 25 forms the essential interface between the Ethernet controllers 28 . . . 31 and a microprocessor bus 21. The microprocessor interface 25 controls or arbitrates write and read access to the RAM 22 via the DMA controller 33 or the DMA controller 26. If there are simultaneous DMA requests from the two DMA controllers 26 and 33, the microprocessor interface 25 decides on the access rights of the two DMA channels. Via the microprocessor interface 25, the microprocessor 23 can write into parameter registers 34, which are necessary to operate the communication interface of the network subscribers. Examples include a pointer to the beginning of the high-priority memory area in a transmit buffer of an Ethernet controller, a pointer to the beginning of the high-priority memory area in each of the receive buffers of the Ethernet controller, a mode register for general control bits, an address of the series to which the network subscriber belongs, a cycle time for so-called port select messages, and the settings of different monitoring time intervals.

Preferably, the transmit buffer 27 has a size of more than three kilobytes and is divided into a memory area for high-priority and a memory area for low-priority messages. The ratio of the two memory areas can be parameterized. The memory areas of the transmit buffer for high-priority and low-priority data are each implemented as ring buffers. Data transmission from the transmit buffer 27 via one or more Ethernet controllers 28 . . . 31 is started when the number of the entered bytes of a message is larger than the parameterizable filling level, or when a complete message has been copied from the RAM 22 into the transmit buffer 27, and at least one of the Ethernet controllers 28 . . . 31 is free for the transmit operation.

The Ethernet controllers 28 . . . 31 are structured identically. Their structure will be described in greater detail by means of the example of the Ethernet controller 28. A device 40, referred to as transmit control, includes a control unit that is responsible for the transmitting, repeating, aborting, etc. of messages. The device 40 forms the interface between the internal controller clock and the transmitter clock. To store transmit status information for low-priority and high-priority messages, a transmit status register each is provided in the device 40. If a message has been transmitted via the port without errors, a corresponding interrupt is generated.

A media independent interface 41 (MII) integrates the MAC-sublayer of the layer 2 according to the seven-layer model, i.e., the data link layer. The data link layer forms an interface to a component 36 for physical data transmission. The MII 41 further comprises a transmit function block 42 and a receive function block 43. Also integrated are a MAC control block (not depicted in FIG. 2), an address filter, a statistics counter, and a host interface. Via the media independent interface MII 41, control and configuration data can be transmitted to and status information read out of a component 36. The individual functions of the transmit function block 42 include: mapping the bytes to be transmitted; detecting collisions in half duplex operation and executing a back-off algorithm; making available transmit status information to the device 40 after completing a transmit process; complying with the inter-packet-gap (IPG) between two messages; adding a preamble, a start-of-frame delimiter and a parameterizable cyclic redundancy check word (CRC) to the transmit data; filling a message with pad bytes if the message length would be <60 bytes; and aborting a transmit process upon an abortion request.

The receive function block 43 provides the received bytes to a device 44, which is also referred to as receive control. The receive function block 43 detects the start-of-frame delimiter and a VLAN frame. The receive function block 43 checks the length field and the CRC word in messages. After completion of the receive process, receive status information is provided to the device 44. The block 43 detects and removes the preamble and start of frame delimiter from messages. If the free memory available in a receive buffer 45 of the Ethernet controller 28 falls below a predefined threshold in full duplex mode, the MAC control block sends a pause control message for flow control via the component 36. This message prompts the connected network subscriber not to send any data messages to the Ethernet controller 28 until the time interval sent with the pause control message has expired. The address filter filters the messages according to unicast, multicast and broadcast addresses. For this purpose, the destination address (DA) received in a message is compared with filter addresses. The statistics counters store statistical information on transmit and receive operations. The host interface permits access to the parameter registers and statistics counters of the Ethernet controller 28 by the respectively adjacent network subscriber.

The device 44 includes a control unit, which is responsible for receiving messages. The device 44 forms the interface between the internal clock of the Ethernet controller 28 and the receive clock.

The receive buffer 45 has a size of more than 3 kilobytes and is divided into a memory area for high-priority and a memory area for low-priority messages. The ratio of the two message areas is parameterizable. The memory areas are each implemented as ring buffers.

The DMA controller 33 controls the DMA transfer from one of the receive buffers in the Ethernet controllers 28 . . . 31 to the RAM 22. The DMA transfer starts when the number of received data bytes in one of the receive buffers, e.g., in the receive buffer 45, has reached a parameterizable minimum filling level, or when a message has been received completely. At the same time, this receive buffer must be selected for DMA transfer by a module 46, which is referred to as switch control.

A multiplexer 47, which is controlled by the module or control unit 46, is connected upstream from the device 40.

The switch control 46 controls the forwarding of the data between the Ethernet controllers 28 . . . 31 and the storing of the received data if the data is intended for the corresponding network subscriber. Since the application of the invention is not limited to networks based on the Ethernet specification, the Ethernet controllers 28 . . . 31 are hereinafter generally also referred to as port 1, port 2, port 3 and port 4. The network structure in which the subscriber is integrated determines which ports are released or activated for forwarding the received data. The switch control 46 controls the following actions as a function of the operational state, the network structure, the received destination address, and the message priority:

If the received destination address is the same as the subscriber's own address, the received message is transferred to the RAM 22 via the microprocessor interface 25 without being forwarded to other ports.

If a port receives a broadcast message, the message is transferred to the RAM 22 and made available to the other released ports for transmitting.

If a port receives a message with a multicast address, which matches one of the multicast addresses stored in a filter table 48, the message is transferred to the RAM 22 and made available to the other released ports for transmitting.

If the received destination address is different from the subscriber's own address and the multicast addresses, the message is made available to the other released ports for transmitting without being stored for further processing.

In messages with so-called VLAN bytes eight priority levels are available, for example. If several messages are simultaneously queued for transmitting, the transmit sequence of the messages is defined according to their transmit priority.

In a monitor mode, all messages that satisfy the parameterized filter conditions are transferred to the RAM 22.

The messages are forwarded taking into account a modified spanning tree algorithm.

The switch control 46 includes still other parameters, the significance of which will be described in greater detail below: a series address R_{P3} that corresponds to the series connected to the port 3; a series address R_{P4} that reflects the address of the series connected to the port 4; a number N_{R1} of the transmission links up to the port 1; a number N_{R2} of the transmission links up to the port 3; a value |N_{R1}−N_{R2}|ₛ of the respective network subscriber; a value |N_{R1}−N_{R2}|_{Sender} from the transmitter or sender of a received port select message, a value |N_{R1}−N_{R2}|ₘᵢₙ as the smallest value thus far received; a source address A_{Sender} of a received message; a source address A_{stored} of the message with the smallest value of amount |N_{R1}−N_{R2}|ₘᵢₙ, a best received combination (Root_ID.Cost.Transmitter_ID.Port_ID)_{P3} for the port 3; a best received combination (Root_ID.Cost.Transmitter_ID.Port_ID)_{P4} for the port 4; a best received combination (Root_ID.Cost.Transmitter_ID.Port_ID)_{R} of the series; a message interval counter for a cycle time of port select messages; a timeout counter for a timeout interval at the port 1; a timeout counter for a timeout interval at the port 2; a timeout counter for a timeout interval at the port 3; an active time counter for a time interval that starts with the most recent receipt of a port select message at the port 4; a combination aging counter for a maximum time interval within which a configuration message must be received because the stored combination Root_ID.Cost.Transmitter_ID.Port_ID will otherwise be deleted; a counter for a time interval Δt_{seriesdelay}, after which the port 3 of a series is switched from inactive to active, which corresponds to twice the worst-case runtime of a port select message through the series; and a counter for a time interval Δt_{netdelay}, after which a port is switched from potentially active to active and which corresponds to twice the worst-case runtime of a configuration message through the network.

In the filter table 48, the user can enter multicast and virtual LAN identification addresses, so-called VLAN addresses. A multicast or VLAN message is accepted only if the received address matches one of the addresses contained in the filter table 48. A device 50 for redundancy control in a network is intended to ensure that detected physical errors do not affect communication between the network components. On the one hand, redundancy exists within each series formed by network subscribers. For this purpose, the network subscribers connected in series must form a ring that remains open at one point if there is no error but can be closed in the instance of an error. On the other hand, redundancy is possible with several communication channels between the seriess. For this purpose, a series of network subscribers must be connected with a neighboring series via at least two ports. Only one communication channel is active at a time between two seriess, i.e., data messages are exchanged only via this communication path. If an active communication channel between two seriess is detected to be faulty, it is deactivated and the system switches to a different communication channel. To implement redundancy, the device 50 includes a cycle time register with a parameterized cycle time for test messages, a cycle time counter for generating a cycle time interval, a control unit for switching to a redundant communication channel and for prompting transmission of so-called link-up or link-down messages, a series runtime register with a parameterized worst-case runtime of a message through a series, and a series run timer for generating a series runtime.

Via a device 51 for interrupt control, which his also referred to as interrupt control, the microprocessor 23 learns about certain events. These are essentially reports on transmitted or received messages and error messages. The device 51 includes an interrupt request register, an interrupt mask register, an interrupt register, and an interrupt acknowledge register. Each event is stored in the interrupt request register. Individual events can be suppressed via the interrupt mask register. Only the events that have not been masked by the interrupt mask register appear in the interrupt register. Entry in the interrupt request register, however, is independent of the interrupt mask in the interrupt mask register. With write access to the interrupt acknowledge register, bits in the interrupt request register can be reset. A module 52 contains special user functions that are integrated in the communication interface of the network subscriber. A partial function is implemented with a module 53 for clock synchronization; another partial function is implemented with a module 54 for equidistance, which will be described in greater detail below. A delay timer 1 to 4 with reference numerals 57, 58, 59 and 60 is provided, respectively, for the ports 1 to 4 and determines the transmit time between the respective network subscriber and the network subscriber that is connected via the corresponding port. The respective delay timer is also used as a runtimer (DLZ timer) for the corresponding port. Also provided for each port are an equidistance timer and an auxiliary timer for a transmit time Δt₁ via the respective port and a parameter Δt_{DLZ}, which corresponds to the sum of the runtimes in transmit and receive direction and the line runtime between the communication interface and the network subscriber connected via the corresponding port. Furthermore, a local clock 37 is provided in the network subscriber, the clock time of which can be read and adjusted via the microprocessor bus 21.

An integrated serial peripheral interface (SPI) 55 is a simple but powerful serial bus system for connecting peripheral components, e.g., EEPROMs. An integrated I/O interface 56 is a parallel interface with 12 parameterizable inputs and outputs. For instance, LEDs for status display can be controlled via this interface. Each port of the communication interface is parameterizable to be operated in half duplex or in full duplex mode. Half duplex mode can be set at one port and, at the same time, full duplex mode can be parameterized at a different port. In full duplex mode, messages can be simultaneously transmitted and received. This is not possible in half duplex mode.

An application-specific program that can be stored, for instance, in RAM 22 enters data to be forwarded into a job list in RAM 22. DMA controller 26 copies data from this job list into transmit buffer 27. Compiled messages are forwarded to the released Ethernet controllers 28 . . . 31. If a transmission conflict occurs because other messages controlled by switch control 46 are simultaneously being forwarded through the communication interface, transmit buffer 27 should be capable of storing two complete Ethernet messages. Data transmission from transmit buffer 27 is started when a parameterizable number of data bytes or a complete message have been transferred from RAM 22 into transmit buffer 27 and at least one Ethernet controller is free. The message remains stored in transmit buffer 27 until it has been transmitted via all released Ethernet controllers 28 . . . 31. The number of data bytes of a message that must at minimum be stored in transmit buffer 27 before transmission takes place should be parameterized so as to ensure gapless transmission of the messages. Otherwise the message will be received with errors by the other network subscribers. If messages with different priorities are stored in the transmit buffer, the messages are transmitted according to their transmission priority.

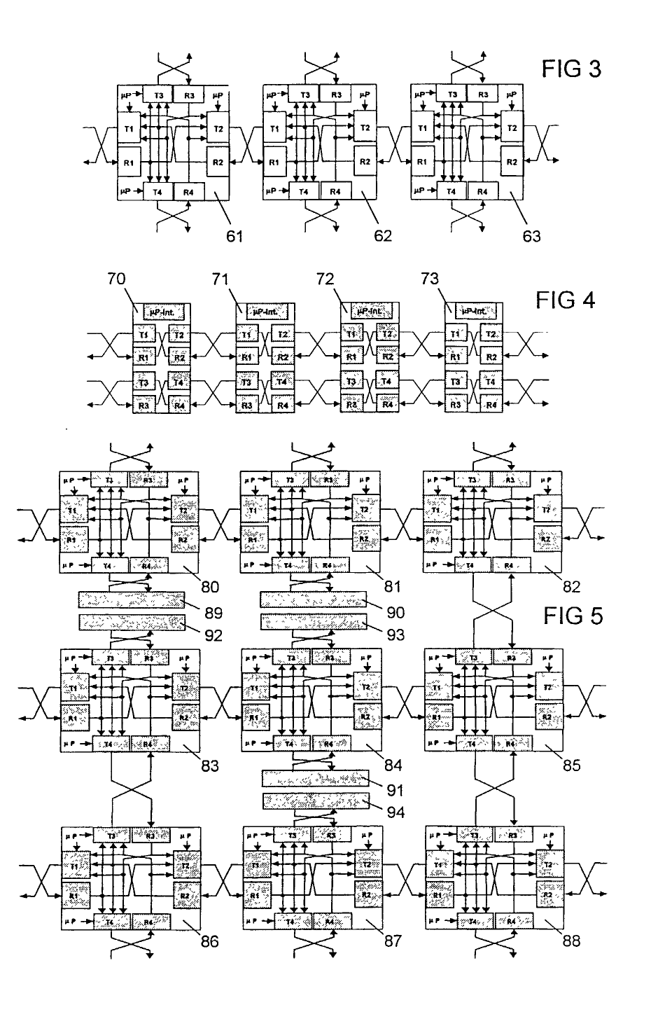

FIG. 3 shows an example of an interconnection of three network subscribers 61, 62 and 63 in a linear structure. For better clarity, ports 1 to 4 of the communication interface of network subscribers 61, 62, and 63 are divided into circuit parts T1 to T4 for transmit direction and circuit parts R1 to R4 for receive direction. Thus, port 2, for instance, can also be referred to as Port T2/R2 for short. For a linear structure, port T2/R2 of network subscriber 61 is connected with Port T1/R1 of network subscriber 62, and port T2/R2 of network subscriber 62 with port T1/R1 of network subscriber 63. The data is transmitted via a twisted pair cable for each transmission direction. The ports involved can thus be operated in full duplex mode. Terminals may optionally be connected to ports T3/R3 and T4/R4, which are open in FIG. 3, and to port T1/R1 of network subscriber 61 or port T2/R2 of network subscriber 63 and are thereby coupled to the network.

FIG. 4 shows a series of network subscribers 70, 71, 72 and 73, which can exchange data with one another via two communication channels each. The communication channels are each realized by connecting port T2/R2 with port T1/R1 of the adjacent network subscriber and port T4/R4 with port T3/R3 of the adjacent network subscriber as described. This makes it possible, for instance, to set up a high-priority and a low-priority communication channel and thereby to double the data throughput. A data exchange between the communication channels does not take place, i.e. a message received at circuit part R1 can—if required—be forwarded only by circuit part T2. Both communication channels are operated in full duplex mode.

An example of a two-dimensional interconnection of the network subscribers is depicted in FIG. 5. Network subscribers 80, 81, and 82 are interconnected in a series as described with reference to FIG. 3. In addition, network subscribers 83, 84 and 85 form a series, and network subscribers 86, 87 and 88 form a series. Terminals 89, 90 or 91 are connected, respectively, to ports T4/R4 of network subscribers 80, 81 and 84, and terminals 92, 93 and 94 to ports T3/R3 of network subscribers 83, 84 and 87. By linking port T4/R4 of network subscriber 82 with port T3/R3 of network subscriber 85, a communication channel is realized between the corresponding seriess. Likewise, two communication channels are formed between network subscribers 83 and 86 and network subscribers 85 and 88. To ensure that there are no loops in the network, only one of these communication channels may be switched to active at a time.

The seriess formed by users 80 to 82, 83 to 85 and 86 to 88 are each assigned a unique series address Rₖ, which is stored in a series address parameter register.

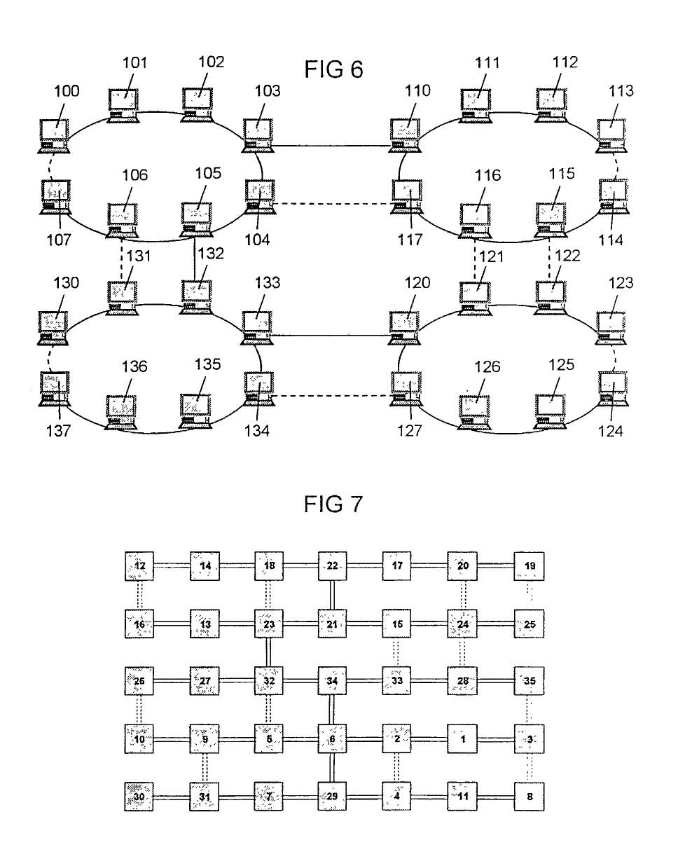

FIG. 6 shows an additional two-dimensional network to illustrate redundancy control. Eight network subscribers, respectively, 100 . . . 107, 110 . . . 117, 120 . . . 127 and 130 . . . 137 are interconnected in a series. Both the connections between network subscribers that are drawn with dashed lines and the connections drawn with solid lines represent communication channels. It must be ensured, however, that only a single communication path in the entire network is used between any two network subscribers. If there were several possible communication paths, loops would occur, i.e. messages would multiply and circulate. The spanning tree algorithm was developed to prevent this type of situation. Data messages are only received by ports, forwarded to ports and transmitted by ports which are contained in the spanning tree. The remaining ports are deactivated. Deactivated communication channels are represented by broken lines in FIG. 6, activated ones by solid lines. For redundancy within a series, the two line ends, e.g. at network subscribers 100 and 107 are interconnected. If there is no error, the communication channel thus created is deactivated, if there is an error it is switched to the active state. This redundancy presumes an uninterrupted line structure. Since the spanning tree algorithm would possibly also interrupt a connection via ports T1/R1 and T2/R2, it cannot be used without modification. A method will now be presented, which ensures freedom from loops for a network of interconnected seriess of network subscribers, without having to interrupt a series. For this purpose—if required—only ports T3/R3 are deactivated. Only one communication channel between two seriess each may be active at a time, i.e. data messages are exchanged via this communication path. No data exchange takes place via the other communication paths between two seriess. The single active communication channel between two seriess each is selected by means of port select messages. These are messages that are forwarded only within a series. They are not exchanged between seriess.

The purpose of these port select messages is to find a network subscriber that is connected via port T3/R3 with a neighboring series and that in relation to the number of network subscribers is as equidistant as possible from the two ends of the line structure, i.e. it has the smallest distance from the center of the series. These properties define the only network subscriber of the series that is actively connected with an adjacent series via port T3/R3. All other connections via ports T3/R3 of network subscribers of the same series to this adjacent series are deactivated. No data messages are exchanged via deactivated communication channels.

Port select message are uniquely identified by an ID in the type field.

FIG. 7 shows the result of redundancy control in a two-dimensional network in a different representation. The number entered into the individual boxes corresponds to the address of the respective network subscriber. Port T1/R1 is on the left side, port T2/R2 on the right side, port T3/R3 at the top and port T4/R4 at the bottom of the network subscribers. Two solid parallel lines between two users indicate an active communication channel operated in full duplex mode. The communication channels indicated by dashed lines are deactivated.

The data area of port select messages that a network subscriber receives via port T2/R2 contains information on the number N_{R2} of transmission links between port T1/R1 of the network subscriber at the “right” end of the series and port T2/R2 of the corresponding network subscriber, and contains the number N_{R1} of the user that last forwarded or transmitted the received port select message.

The data area of port select messages that are received via port T1/R1 contains the number N_{R1} of transmission links between port T2/R2 of the network subscriber at the “left” end of the series and port T1/R1 of the respective network subscriber, as well as the number N_{R2}, which is valid for the network subscriber that last forwarded or transmitted the received port select message.

Independent of the port via which a port select message was received, the message contains the value |N_{R1}−N_{R2}|_{Initiator} at the initiator of the received port select message, the 16-bit address Rₖ (0≦k≦p, p number of seriess) of the series to which the initiator of the port select message belongs, and a valid bit V for the received value of |N_{R1}−N_{R2}|_{Initiator} and for the series address Rₖ. V=0 means that the received values are invalid. Such a port select message was fed into the series by a network subscriber that is not connected with its neighboring series via an available port T3/R3. If V=1 the received values are valid. The port select message was fed into the series by a network subscriber that is connected with a neighboring series via an available port T3/R3. A connection to a neighboring series is available if a port select message was received at port P3/R3 within a parameterizable time interval Δtₜᵢₘₑₒᵤₜ (timeout interval). This is possible only if port T3/R3 of the network subscriber of that series and port T4/R4 of the network subscriber of the neighboring series are each in a “link-pass” state. In this state, messages can be transmitted in both directions.

In the steady state, only one network subscriber in each series is still cyclically sending port select messages, i.e. in each signaling interval Δt_{M}, and it is the only one actively linked with the next series via port T3/R3. This makes it possible to detect whether this link between seriess is still active. A method for identifying this network subscriber will now be described.

1. Network subscribers transmit port select messages that are to be forwarded or that they themselves compiled in addition via their port T3/R3.

2. Each network subscriber detects by the receipt of a port select message via port T3/R3 whether it is connected to another series via this port. Network subscribers set the valid bit V to one if a port select message was received via port T3/R3.

3. Port select messages received at port T3/R3 are returned unchanged to the transmitter. Prior to that, the network subscriber stores address Rₙ of the series connected via port T3/R3, which it received with the port select message.

4. Port T3/R3 is assigned a timeout counter, which is incremented at an adjustable clock pulse. Each port select message received at port T3/R3 resets this timer. The network subscriber sets the valid bit V to zero if no port select message is received within a parameterizable timeout interval Δtₜᵢₘₑₒᵤₜ.

5. Network subscribers send port select messages that are to be forwarded or that they themselves compiled in addition via port T4/R4.

6. A network subscriber detects by the receipt of a port select message via port T4/R4 that it is connected with another series via this port.

7. Port select messages received at port T4/R4 are returned unchanged to the transmitter. Prior to that, the network subscriber stores address Rₙ of the series connected via port T4/R4, which it received with the port select message.

8. Network subscribers send their own port select messages, i.e. those that they themselves compiled

8.1 via port T1/R1 with N_{R2}=1 and port T2/R2 with N_{R1}=1 upon initialization with amount |N_{R1}−N_{R2}|_{Initiator}=FFH and valid bit V=1, if a port select message was previously received via port T3/R3, or valid bit V=0 if no port select message was received via port T3/R3.

8.2 via T1/R1 with N_{R2}=1 and port T2/R2 with (N_{R1}+1), if no port select message or data message was received at port T2/R2 within a parameterizable time interval Δtₜᵢₘₑₒᵤₜ. Port T2/R2 is assigned a timeout counter that is incremented at an adjustable clock pulse. Each port select message or data message received at port T2/R2 resets this timer.

8.3 via port T1/R1 with (N_{R2empf}+1) and port T2/R2 with (N_{R1}+1) if a port select message is received at port T2/R2 with a received value N_{R2empf} that is not equal to the stored value of N_{R2}. In addition, N_{R2empf} is stored.

8.4 via port T2/R2 with (N_{R1}+1) if a port select message is received at port T2/R2 with N_{R1LastSender} not equal to (N_{R1}+1).

8.5 via port T2/R2 with N_{R1}=1 and port T1/R1 with (N_{R2}+1) if no port select message or data message was received at port T1/R1 within a parameterizable time interval Δtₜᵢₘₑₒᵤₜ. Port T1/R1 is assigned a timeout counter that is incremented at an adjustable clock pulse. Each port select message or data message received at port T1/R1 resets this timer.

8.6 via port T2/R2 with (N_{R1empf}+1) and port T1/R1 with (N_{R2}+1), if a port select message with a received value N_{R1empf} that is not equal to the stored value of N_{R1} is received at port T1/R1. In addition, N_{R1empf} is stored.

8.7 Via port T1/R1 with (N_{R2}+1), if a port select message with N_{R2LastSender} not equal to (N_{R2}+1) is received at port T1/R1.

9. Network subscribers that are linked to another series via an available communication channel through port T3/R3 and that receive a port select message with a valid bit V set to one compare |N_{R1}−N_{R2}|_{Initiator} from the received port select message with amount |N_{R1}−N_{R2}| s of their own station:

9.1 If |N_{R1}−N_{R2}|_{Initiator}<|N_{R1}−N_{R2}| s, |N_{R1}−N_{R2}|_{Initiator} is not changed in the data field of the port select message upon forwarding. The network subscriber stores

|N_{R1}−N_{R2}|ₘₘ=|N_{R1}−N_{R2}|_{Initiator} and sets the address A_{stored}=A_{Initiator}. A_{Initiator} is the source address of the received port select message. The value |N_{R1}−N_{R2}| s is the distance of the receiving station from the center of the series.

9.2 If |N_{R1}−N_{R2}|_{Initiator}=|N_{R1}−N_{R2}| s A_{Initiator} is compared with the network subscriber's own station address Aₛ.

If A_{Initiator}<Aₛ the port select message is forwarded without any change in the data field with |N_{R1}−N_{R2}|_{Initiator}. The network subscriber stores |N_{R1}−N_{R2}|ₘᵢₙ=|N_{R1}−N_{R2}|ₛ and A_{stored}=A_{Initiator}.

If A_{Initiator}=Aₛ the received port select message is filtered out since this case is possible only if there is an error.

If A_{Initiator}>Aₛ the received port select message is filtered out and the network subscriber sends its own port select message with |N_{R1}−N_{R2}|_{Initiator} set to |N_{R1}−N_{R2}|ₛ via ports T1/R1 and T2/R2. The network subscriber stores |N_{R1}−N_{R2}|ₘᵢₙ=|N_{R1}−N_{R2}|ₛ and A_{stored}=Aₛ.

9.3 If |N_{R1}−N_{R2}|_{Initiator}>|N_{R1}−N_{R2}|ₛ the received port select message is filtered and the network subscriber sends its own port select message with |N_{R1}−N_{R2}|_{Initiator} set to |_{N}_{R1}−N_{R2}|ₛ via ports T1/R1 and T2/R2. The network subscriber stores |N_{R1}−N_{R2}|ₘᵢₙ=|N_{R1}−N_{R2}|ₛ and A_{stored}=Aₛ.

10. Network subscribers that are not connected to another series via port T3/R3 or are connected via an unavailable communication channel and that receive a port select message with a valid bit V=1, forward the message with the received valid bit V and the value |N_{R1}−N_{R2}|_{Initiator} within the series. The network subscriber stores |N_{R1}−N_{R2}|ₘᵢₙ=★N_{R1}−N_{R2}|_{Initiator} and A_{stored}=A_{Initiator}.

11. Network subscribers that receive a port select message with a valid bit V=0 forward the message with V=0 and the value |N_{R1}−N_{R2}|_{Initiator} within the series. The stored values |N_{R1}−N_{R2}|ₘᵢₙ and A_{stored} remain unchanged.

12. An available port T3/R3 is switched to active if |N_{R1}−N_{R2}|ₘᵢₙ=|N_{R1}−N_{R2}|ₛ and if A_{stored}=Aₛ is stored. This applies to a time period Δt_{seriesdelay} which corresponds to at least twice the worst-case runtime of a port select message through a series.

13. An active port T3/R3 of a network subscriber is deactivated if the network subscriber does not receive a port select message from another series within the timeout interval Δtₜᵢₘₑₒᵤₜ. In addition, the communication channel to the other series via port T3/R3 is flagged as unavailable.

An active port T3/R3 is also deactivated if the network subscriber receives a port select message with |N_{R1}−N_{R2}|_{Initiator}<|N_{R1}−N_{R2}|ₛ or |N_{R1}−N_{R2}|_{Initiator}=|N_{R1}−N_{R2}|ₛ and A_{Initiator}<Aₛ. This network subscriber stores the received values |N_{R1}−N_{R2}|_{Initiator} and A_{Initiator} and forwards the received message. The communication channel to the other series via port T3/R3 remains available.

14. Network subscribers that are linked to another series via an available communication channel through port T3/R3 cyclically transmit their own port select messages in each signaling interval Δt_{M}

14.1 via port T1/R1 with (N_{R2}+1) and port T2/R2 (N_{R1}+1) if an active port T3/R3 is deactivated, where |N_{R1}−N_{R2}|_{Initiator}=FFH and valid bit V=1 until a port select message of another network subscriber is received;

14.2 via port T1/R1 with (N_{R2}+1) and port T2/R2 with (N_{R1}+1) if within a parameterizable time interval Δtₜᵢₘₑₒᵤₜ no port select message or data message from the network subscriber with the single active communication channel to the neighboring series, i.e. a message with the source address A_{stored}, was received at port T1/R1 or port T2/R2.

14.3 via port T1/R1 with (N_{R2}+1) and port T2/R2 with (N_{R1}+1) if |N_{R1}−N_{R2}|ₘᵢₙ=|N_{R1}−N_{R2}|ₛ and A_{stored}=Aₛ.

In the steady state of the process each network subscriber of the series knows the network subscriber that is linked with a neighboring series via its port T3/R3 and has the shortest distance from the center of the series. Data messages between seriess are exchanged only via this active communication channel. The links of the other network subscribers to the next series are deactivated. FIG. 7 shows a network in this steady state.

If in deviation of this exemplary embodiment the single active communication channel of a series to the neighboring series lies at the end of the series, |N_{R1}−N_{R2}|ₘᵢₙ must be replaced with |N_{R1}−N_{R2}|ₘₐₓ, and |N_{R1}−N_{R2}|_{Initiator}<|N_{R1}−N_{R2}|ₛ with |N_{R1}−N_{R2}|_{Initiator}>|N_{R1}−N_{R2}|ₛ.

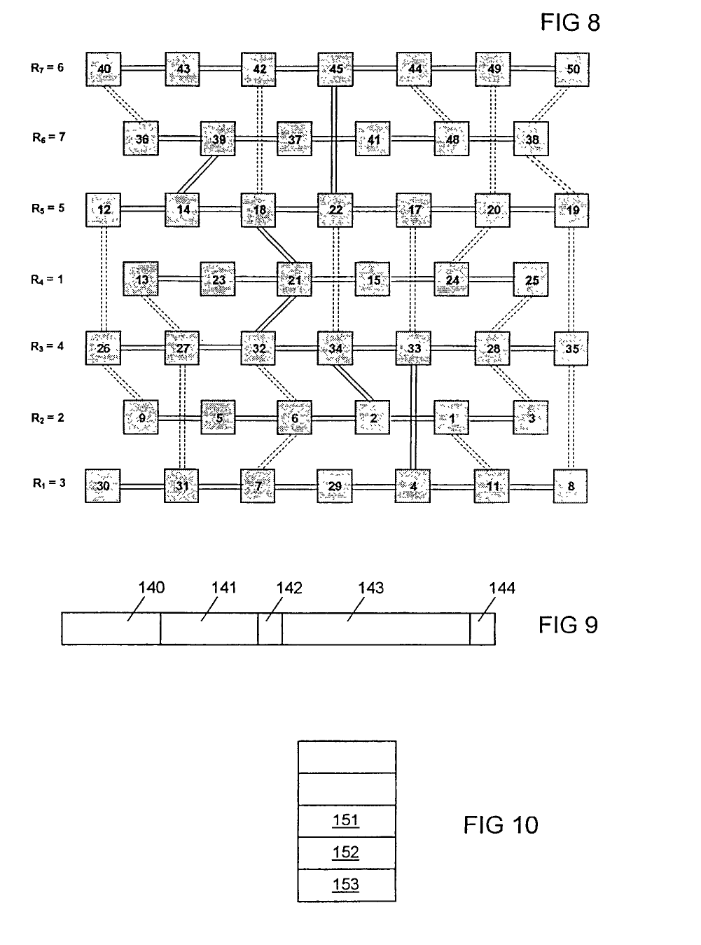

FIG. 8 shows a network with a three-dimensional structure. The arrangement of the ports on the individual boxes, each of which represents a network subscriber with the entered address, is the same as in the representation according to FIG. 7. The communication channels are also represented in the same manner. In a three-dimensional structure, a series with a linear structure is formed by a plurality of network subscribers by linking ports T1/R1 and T2/R2. A plurality of these seriess is interconnected into a three-dimensional structure as depicted in FIG. 8. For this purpose at least one communication channel via port T3/R3 and T4/R4 must exist between each of two seriess. A plurality of communication paths between each of two seriess is permissible. Terminals may be connected to network subscriber ports T3/R3 and T4/R4 that are not used for communication channels between seriess. Each series is assigned a unique series address Rₖ with 0≦k≦p, where p is the number of seriess of the selected network structure. The respective series addresses are indicated on the left side of FIG. 8 next to the corresponding series. In each network subscriber, the associated address of the series is stored in the “series address” parameter register.

It must be ensured, however, that only a single communication path is used between any network subscribers within the entire network. If there were several communication paths loops would occur, i.e. messages could multiply and circulate. To prevent loops, port select messages are used in combination with a modified spanning tree algorithm.

For this purpose, the data area of the port select message is expanded by address Rₙ of the adjacent series to which port T3/R3 or port T4/R4 of the network subscriber that compiled the message is linked.

The purpose of the port select messages expanded by series address Rₙ of the adjacent series is to find a network subscriber which is linked to a series with address Rₙ via port T3/R3 and which in relation to the number of network subscribers is as equidistant as possible from the two ends of its series, i.e. has the shortest distance from the center of the series. This defines the single network subscriber of the series that is potentially actively connected to the neighboring series with address Rₙ via port T3/R3. Port T3/R3 is switched from potentially active to active if the modified spanning tree algorithm also switches this port to active. Data messages are exchanged only via active communication channels between seriess. The method, which has already been described for the two-dimensional network structure, makes it possible to find the network subscriber that has the shortest distance from the center of the series and whose port T3/R3 is linked to the series with address RN. The port select messages ensure that between two seriess which are directly interconnected via communication channels, only one communication channel via port T3/R3 is potentially active at a time. To reliably prevent loops that might be formed over more than two seriess, a modified spanning tree method ensures that no loop occurs over the entire three-dimensional network.

The modified spanning tree method is characterized in that each series is considered a virtual switch, with the potentially active communication channels via ports T3/R3 or ports T4/R4 to other seriess being the ports of the virtual switch, and that a communication channel via port T4/R4 is potentially active if it is connected to a potentially active port T3/R3 of another series which is also considered a virtual switch. Furthermore, the following entries in the data field are provided in configuration messages:

1. Root_ID: a 64-bit address R_{R} of the virtual switch, which is assumed to be the “root.”

2. Transmitter_ID: A 64-bit address R_{T} of the virtual switch to which the transmitting network subscriber belongs. Addresses R_{R} and R_{T} each correspond to the address of the series that is considered the virtual switch.

3. Cost: Smallest number of seriess that a message must pass through from a transmitter to the Root_ID.

4. Port_ID: A 16-bit address P_{ID} of the port via which the transmitting virtual switch sends the configuration message. R_{PID} is equal to the address R_{D} of the series that is connected to the port via which the virtual switch is transmitting with the Transmitter_ID.

With these definitions, the spanning tree algorithm can be applied to a network of virtual switches. It is based on the described configuration messages that are sent and received by virtual switches. Only the potentially active or active ports T3/R3 or T4/R4 of a series, i.e. of a virtual switch, evaluate received configuration messages. The deactivated ports T3/R3 or T4/R4 evaluate the configuration messages and subsequently filter them. The spanning tree method switches ports T3/R3 or T4/R4 from potentially active to active, ensuring that only a single communication path exists between any two network subscribers of the network and consequently no loops occur. The remaining ports T3/R3 or T4/R4 remain potentially active or deactivated. Data messages are exchanged only over active communication channels between the seriess.

A virtual switch is always available to receive configuration messages at its ports and for each port stores the configuration message with the “best” combination of Root_ID.Cost.Transmitter_ID.Port_ID. Not only are the received combinations compared for each port, but there is also a comparison with the combination that the virtual switch would send to this port. A combination K1 is “better” than another combination K2 if

1. Root_ID of K1<Root_ID of K2,

2. Root_ID of K1=Root_ID of K2 and

Cost of K1<Cost of K2,

3. Root_ID of K1=Root_ID of K2 and

Cost of K1=Cost of K2 and

Transmitter_ID of K1<Transmitter_ID of K2 or

4. Root_ID of K1=Root_ID of K2 and

Cost of K1=Cost of K2 and

Transmitter_ID of K1=Transmitter ID of K2 and

Port_ID of K1<Port_ID of K2.

The root port of a virtual switch is the port with the “best” received combination

K_{R}=K_{E}=Root_ID.Cost.Transmitter_ID.Port_ID.

The root port is the port of a virtual switch with the shortest distance to Root_ID.

The combination of the root port is communicated to all network subscribers of the virtual switch via port select messages. Thus, each network subscriber has the information required to decide whether a port should be switched from potentially active to active. A potentially active port is switched to active if Root_ID.(Cost+1).Transmitter_ID.Port_ID of the root port is “better” than Root_ID.Cost.Transmitter_ID.Port_ID of the port considered.

The condition that leads to the activation of a port of a virtual switch must be valid for a time period Δt_{netdelay}, which corresponds to at least twice the worst-case runtime of a configuration message through the network before the respective port is actually activated. Only configuration messages that were received by the root port are forwarded to the active ports of the virtual switch. Configuration messages are sent or forwarded only via active ports T3/R3. The only recipients of these messages are thus the potentially active ports T4/R4 of the connected virtual switches. In addition, configuration messages are transmitted or forwarded only via active ports T4/R4. The only recipients of such messages are thus the potentially active ports T3/R3 of the connected virtual switches. Each port of a virtual switch is assigned a so-called combination aging counter. This counter is reset and restarted with each received or forwarded configuration message. The combination aging counter is thus activated only in the potentially active or active ports of a series and is incremented with a parameterizable time pulse. If the combination aging counter reaches the parameterizable “maximum age” threshold in a potentially active or an active port, the combination Root_ID.Cost.Transmitter_ID.Port_ID stored for this port is deleted and recalculated.

The information exchange within a virtual switch, i.e. within a series of network subscribers with linear structure, takes place with port select messages, which resemble the above-described port select messages of a network with two-dimensional structure. Compared to the data area of the port select messages for a network with a two-dimensional structure, the data area of the port select messages of a network with a three-dimensional structure is expanded independent of the receiving port by a 16-bit address Rₙ of the virtual switch which is connected via port T3/R3, i.e. of the neighboring series, whose validity is indicated by the previously described valid bit V. If V=0 the received value of series address Rₙ is also invalid. The port select message was fed into the virtual switch by a network subscriber that is connected with the virtual switch via an available port T4/R4. If V=1 address Rₙ is valid. In addition, a potentially active bit P_{pA} is inserted in the data area of the port select message. Depending on the receiving port, this bit has either of two meanings:

1. P_{pA} in port select messages that were received at port T4/R4 inform the network subscriber whether port T3/R3 of the transmitting network subscriber of the connected virtual switch is potentially active or active (P_{pA}=1) or deactivated (P_{pA}=0).

2. P_{pA} in port select messages that were received at port T1/R1 or port T2/R2 informs the network subscriber whether port T4/R4 of the initiator of the port select message is potentially active or active (P_{pA}=1) or deactivated (P_{pA}=0).

Furthermore, the data area of the port select message is expanded by a 16-bit address Rₙ of the virtual switch connected via port T4/R4. The value of the address is necessary only if P_{pA}=1 is set.

In addition, a value of an active timer at the instant of transmission is transmitted in the port select messages. The active timer measures the time that has passed since a port select message has last been received via port T4/R4 with the potentially active bit set, i.e. with P_{pA}=1. The value of the active timer is valid only if P_{pA}=1.

The data area of port select messages for a three-dimensional network structure further comprises the best received combination for this port

K_{E}=Root_ID.Cost.Transmitter_ID. Port_ID,

which was sent or forwarded in the data field of a configuration message from a series connected to a potentially active or active port T3/R3 or T4/R4 with the address Rₙ or Rᵢ.

In addition, the best currently known combination is transmitted to the potentially active or active port T3/R3 and T4/R4 of the series, i.e. of the virtual switch, in the data field of port select messages:

K_{R}=Root ID.Cost.Transmitter_ID.Port_ID.

A network subscriber which receives a port select message at a deactivated port T4/R4 from a potentially active or active port T3/R3, i.e. a port select message with P_{pA}=1, of another series, switches port T4/R4 to potentially active or active and sends a parameterizable number of port select messages with P_{pA}=1.

Ports T4/R4 are each assigned an active timer that is incremented at an adjustable clock pulse. The active timer measures the time elapsed since a port select message with the potentially active bit set, P_{pA}=1, has last been received. Each port select message with the potentially active bit set, P_{pA}=1, which is received via port T4/R4 resets the active timer and restarts it. Received port select messages with P_{pA}=0 reset the active timer without starting it.

A network subscriber with a potentially active or active port T4/R4 deactivates this port if

1. it receives via port T4/R4 a port select message with P_{pA}=0,

2. it receives via a port T1/R1 or T2/R2 a port select message with P_{pA}=1 and a received value of the active timer that is smaller than its own active time; in this case its own active timer is reset without being restarted, or

3. the time measured by the active timer reaches a parameterizable maximum value.

In the steady state, all network subscribers in each virtual switch, i.e. in each series, with a potentially active T3/R3 connection to an adjacent series which is connected via ports T3/R3 cyclically transmit a port select message within each signaling interval Δt_{M} via ports T1/R1 and T2/R2.

In addition, the following network subscribers in each virtual switch send a port select message via ports T1/R1 and T2/R2:

1. each network subscriber upon initialization with

K_{R}=K_{D}=SourceAddress.0.SourceAddress.Port_ID,

2. each network subscriber with a potentially active communication channel via port T3/R3 to a series with the address Rₙ if it receives a configuration message via port T3/R3,

3. each network subscriber with a potentially active communication channel via port T4/R4 to a series with the address Rᵢ if it receives a configuration message via port T4/R4,

4. each network subscriber in which the combination aging counter of a potentially active or active port reaches the “maximum age” threshold value; the combination K_{E} and K_{R} stored for this port is deleted and recalculated and a port select message with

K_{R}=K_{E}=SourceAddress.0.SourceAddress.Port_ID

is initially transmitted,

5. each network subscriber with a potentially active or active port whose stored combination K_{R} is “better” than the combination K_{R} in the received port select message; the combination K_{R} stored for this port is deleted and recalculated and a port select message with the best combination received thus far for this port

K_{E}=Root_ID.Cost.Transmitter_ID. Port_ID and with

K_{R}=min{K_{E}, received value of K_{R}} is transmitted, and

6. each network subscriber whose port T4/R4 is switched from deactivated to potentially active or active sends a parameterizable number of port select messages with P_{pA}=1.

All recipients of a port select message with a deactivated communication channel to another series store the values K_{E} and K_{R} transmitted from the associated potentially active or active port of the virtual switch.

FIG. 8 shows the result of the application of the port select messages in combination with the modified spanning tree method to each series of the depicted three-dimensional network.

Redundancy in the network is to ensure that physical errors, electromagnetic interference, network expansions, or component replacement do not impair the communication between the network components. A prerequisite therefor is not only rapid detection of errors or network modifications and rapid network reconfiguration but also a smallest possible network area which is affected by the error or the network modification during the reconfiguration time.

Redundancy management provides redundancy within each series of a network relative to the communication channels between two respectively interconnected seriess and redundancy relative to the entire network. The modified spanning tree algorithm ensures freedom from loops.

This type of redundancy advantageously permits short reconfiguration times with a minimum amount of hardware and can thus be implemented at low cost. In addition, the network area that is affected by an error or a network configuration during the reconfiguration time is limited.

To ensure redundancy in a series of linearly interconnected network subscribers, a ring is formed as shown in FIG. 6, e.g. with network subscribers 100 . . . 107. A network subscriber, e.g. network subscriber 100, which is located at one end of the series, must be operated in redundancy mode. It has the function of a redundancy manager.

This network subscriber is switched to redundancy mode by setting a redundancy bit in the parameter register. To check the series, it cyclically transmits at port 1 a Test1 message with the MAC address of port 1 as the source address. The cycle time is e.g. 10 ms. A Test2 message with the MAC address of port 2 as the source address is cyclically transmitted at port 2. The cycle time is again e.g. 10 ms. The Test2 message is transmitted offset by half the cycle time, i.e. 5 ms after the Test1 message. If the series is uninterrupted, the Test1 messages transmitted at port 1 are received again at port 2 and likewise the Test2 messages, in reverse direction. In this case, the communication channel between the two ports 1 and 2 within the network subscriber which is operated as the redundancy manager is disconnected such that all data messages received at port 2 are filtered out and from among the messages received at port 1 only those addressed to its own station address are accepted.

The network subscriber operated as the redundancy manager closes the ring, i.e. it forwards received messages between port 1 and 2 if no test message has been received at either port within a parameterizable time interval of e.g. 100 ms, or if a “link-down” message has been received from a network subscriber of the respective series, which has determined an interruption of the communication channel to the next network subscriber. The port of the network subscriber affected by the interruption is deactivated. The condition for reactivating this port is that the connection to the other network subscriber is restored for a certain minimum time of e.g. 1.6 s, or a “link-up” message is received from the redundancy manager. When the ring is closed, a “link-down” message is transmitted at ports 1 and 2 of the redundancy manager to inform all other network subscribers of the series of the new series structure. Test messages continue to be transmitted cyclically.

The network subscriber operated as the redundancy manager opens the ring if a test message is again received over the previously interrupted link, or if a “link-up” message is received from the network subscriber of the series whose communication channel to the adjacent network subscriber has remained uninterrupted for a certain minimum time of e.g. 1.6 s. As the ring is opened, a “link-up” message is transmitted at ports 1 and 2 of the redundancy manager to inform all the other network subscribers of the series of the new ring structure. Test messages continue to be transmitted cyclically. Each network subscriber of the series resets the registers required for message forwarding when it receives a “link-up” or “link-down” message.

A redundant configuration of the communication channels between two seriess requires at least two separate communication paths. For data exchange between the seriess, however, a maximum of one single path may be used. This potentially active communication channel between two seriess is selected by means of port select messages. If a potentially active communication channel is detected to be faulty it is deactivated and another communication path is switched to potentially active. For the switchover time from deactivated to potentially active the following applies: Switchover time≧Δtₜᵢₘₑₒᵤₜ+Δt_{seriesdelay}, where Δtₜᵢₘₑₒᵤₜ is the timeout interval and Δt_{seriesdelay} corresponds to twice the worst-case runtime of a port select message through the series. The switchover time is thus a function of the number of the network subscribers that form the series. For a series of 50 network subscribers, for instance, it is on the order of magnitude of 200 ms, assuming a timeout interval of 150 ms.

Redundancy in a three-dimensional network is possible in addition. If freedom from loops is already ensured by the network structure, i.e. if no network redundancy exists, each potentially active communication path between two seriess is also active. In this case, the use of the described modified spanning tree algorithm is not required. In case of network redundancy the modified spanning tree algorithm ensures freedom from loops between the seriess. A reconfiguration of a network with the modified spanning tree algorithm is required only in case of errors or network modifications that are not processed by the redundancy within a series or the redundancy of the communication channels between two seriess. In a network with such network subscribers, the transmit time from transmitter to receiver is a function of the number of the network subscribers through which a message is forwarded and it cannot be ignored. The transmit time of a message is increased with each network subscriber that forwards the message by a user-specific delay time Δt₁, which is composed of the following times:

1. Runtime through the physical layer component, e.g. component 36 in FIG. 2, in receive direction from receipt of the first bits of a nibble until the nibble is output as valid at the MII with “RX_DV=1.” This time is e.g. 21 T_{Bit} for DP83843 PHYTER of NSC, where T_{Bit} corresponds to 100 ns at a transmission rate of 10 MBaud and 10 ns at a transmission rate of 100 MBaud.

2. Residence time in the network subscriber from the time when a nibble is received until this same nibble is transmitted. If the user is transmitting its own message and a message is already entered in the receive buffer, the forwarding of the data may be delayed by up to (3 k×8)×T_{Bit} compared to undisturbed operation.

3. Runtime through the physical layer component through which the message is being forwarded in transmit direction from the first rising edge of a transmit clock signal after providing a nibble at the MII until the first bit of this nibble is transmitted. For DP83843 PHYTER of NSC, for instance, this runtime is 6 T_{Bit}.

4. Runtime through the lines between two adjacent network subscribers. The sum of the times indicated under 1, 3 and 4 is a fixed quantity and is referred to as runtime Δt_{DLZ}. It can either be parameterized or measured by the network subscribers. This runtime Δt_{DLZ} can be changed only if a network subscriber is removed from the network or added to the network, or if the cabling is changed.

Runtime Δt_{DLZ} can be determined by the following sequence of messages, which network subscribers execute e.g. after initialization or following a request:

1. Each network subscriber that is newly added to the network sends each of its four neighboring network subscribers a so-called DLZ message, i.e. a first message for determining the runtime. This message is uniquely identified in the 16-bit type address.

2. The new network subscriber starts a DLZ timer 1 after the last nibble of the type field of the DLZ message has been provided to the media independent interface (MII) of port 1 for transmission. Correspondingly, it starts a DLZ timer 2, 3 and 4 for transmission via ports 2, 3 or 4.

3. Each of the maximum of 4 neighboring network subscribers starts its DLZ timer of the respective port after receiving the last nibble of the type field of the DLZ message at its MII. The received DLZ message is not forwarded but is returned to the transmitter, supplemented by the residence time in the corresponding Ethernet controller of the network subscriber. When this neighboring network subscriber has transmitted the last nibble of the type field of the DLZ message thus modified to its MII that is directed toward the added network subscriber, it stops the DLZ timer and sends the residence time stored in the DLZ timer with the data field of the message to the newly added network subscriber.

4. The newly added network subscriber stops the associated DLZ timer 1, 2, 3 or 4 upon receipt of the last nibble of the type field at its MII of the respective port.

5. For instance, for port 1 of the newly added network subscriber, the runtime Δt_{DLZ1} can be calculated according to the formula Δt_{DLZ1}=(T_{DR}−T_{DA}):2,

where T_{DR} is the response time measured with the DLZ timer 1 and T_{DA} is the residence time measured in the neighboring network subscriber.

Runtimes Δt_{DLZ2}, Δt_{DLZ3} and Δt_{DLZ4} are similarly calculated for the remaining ports of the newly added network subscriber. The runtimes thus determined are stored as parameters in module 52 (FIG. 2).

6. The newly added network subscriber sends the measured runtimes with an additional message to the neighboring network subscriber via the respectively assigned port.

Upon initialization of a network, the described determination of the runtimes is required only for each second network subscriber.

Clock synchronization has the purpose of synchronizing the clocks of a plurality or all of the network subscribers. The communication channels between network subscribers are advantageously operated in full duplex mode such that message transmission exhibits a deterministic behavior.

The transmit time from a transmitter to a receiver in a network depends on the number of network subscribers through which the message is forwarded and cannot be ignored.

Clock synchronization may be carried out, for instance, with two special messages. FIG. 9 shows the general structure of a message. A first field 140 contains a destination address, i.e. an address of the user to which the message is directed, and is e.g. 48 bits long. A second field 141 contains a source address, the address of the transmitting network subscriber, which is also e.g. 48 bits long. In a type field 142 of e.g. 16 bits, an identification of the message is transmitted. The useful data of the message is sent in a data field 143 of variable length. The message ends with a check sequence 144, which essentially serves to check the transmission quality. Clock synchronization messages may be identified by a special multicast address as destination address 140 and/or by a type address to be newly defined in type field 142.

FIG. 10 shows a job list, which can be stored, for instance, in RAM 22 depicted in FIG. 2. The messages that are to be transmitted via the network are entered into such a job list. If no transmission prioritization is provided, the message that is lowest on the list is transmitted next. It is thus possible, for instance, that a completed message 151 is transmitted only after transmission of two messages 152 and 153 that had previously been entered in the job list. The transmission delay time of a message in a network subscriber after entry into the job list is thus variable and depends on the number of pending jobs. A means will now be described to prevent the influence of transmit time delays in clock synchronization:

1. A clock master, i.e. a network subscriber to whose clock the clocks of the remaining network subscribers are synchronized, enters an SM-Time0 message, a first clock synchronization message into a job list, starts a delay timer for each port P, P=1, 2, 3, 4, and remembers the start time of these timers.

2. The delay timer of each port P, P=1, 2, 3, 4, is stopped in the clock master after the last nibble of the type field of the SM-Time0 message has been provided for transmission to the MII of the respective port. This defines the transmit delay time. A nibble is defined as half a byte, i.e., it is a sequence of 4 bits.

3. Each adjacent network subscriber, after receiving the last nibble of the type field of the SM-Time0 message at the MII of its port P, P=1, 2, 3 or 4, starts its delay timer with the value of the corresponding runtime Δt_{DLZp}, which has previously been measured according to the above-described procedure or has been entered by an operator. In addition, the address of the clock master, which was received as the source address in the SM-Time0 message, is stored.

4. At the instant when the neighboring network subscriber applies the last nibble of the type field of the SM-Time0 message to forward it to the MII of another port, the value of the delay timer that is assigned to port P, P=1, 2, 3 or 4, is stored. The delay timers continue to run, however. The stored delay times of the ports each correspond to the above-defined transmit time Δt₁ of this network subscriber. With the start value Δt_{DLZp} of the delay timer, the runtime of the message via physical transmission has already been added.

5. Subsequently, the clock master enters an SM-Time1 message that contains the start time of the delay timer in the data field into the job list. Before transmitting this SM-Time1 message via a port P, P=1, 2, 3, 4, it replaces the start time of the delay timer with the clock time at which the last nibble of the type field of the SM-Time0 message was provided for transmission to the MII of this port, i.e. with the sum of the start time of the delay timer and the measured delay time of the respective port P. Thus the clock time corrected by the send time delay is entered into the SM-Time1 message.

6. Each neighboring network subscriber that receives an SM-Time1 message adds the stored delay time Δt₁ of the SM-Time0 message that was previously forwarded via port P, P=1, 2, 3 or 4, to the clock time received in the SM-Time1 message and sends the time thus obtained with an updated SM-Time1 message to the next neighbor via another port. SM-Time1 messages are accepted only by the network subscriber that has previously sent an SM-Time0 message.

With the receipt of the SM-Time1 message, the clock slave, i.e. the neighboring network subscriber, knows the start time of its delay timer. The synchronized clock time results from the sum of the clock time received in the SM-Time1 message and the delay time of the clock slave for each receiving port. Thus the neighboring network subscriber corrects the clock time received in the second message by the runtime and the receive time delay.

The following sequence provides an alternative to the above-described means for clock synchronization with only a single message:

1. A clock master starts the delay timers assigned to the ports and enters the clock time message with the start time of these timers into the job list.

2. The clock master stops the delay timer of each port P, P=1, 2, 3, 4, after the last nibble of the type field of the clock time message has been provided for transmission to the media independent interface of port P, i.e. after the last nibble of the type field has been provided for physical transmission. The network subscriber then adds the start time of the delay timers indicated in the clock time message to the value of the delay timer of the corresponding port P and transmits this sum as the clock time corrected by the transmit time delay with a first clock synchronization message via the corresponding port P.

3. Each neighboring network subscriber, after having received the last nibble of the type field of the first clock synchronization message at a port P, P=1, 2, 3 or 4, starts its associated delay timer with the value of the corresponding runtime Δt_{DLZP}. Thus it measures the time delay since receipt of the first message.

4. At the instant when the neighboring network subscriber applies the last nibble of the type field of the first clock synchronization message to forward it to the MII of a port, the value of the delay timer that is assigned to this port is stored. The delay timers continue to run, however. The stored delay times assigned to the individual ports each correspond to the transmit time Δtᵢ of this network subscriber. The stored delay time is added, respectively, to the received start time of the delay timer and is forwarded with a second clock synchronization message to the next, i.e. a third network subscriber via a different port.

With the receipt of a first or second clock synchronization message, the clock slave knows the start time of its delay timer. The synchronized clock time results from the sum of the clock time received in a first or second message and the delay time of the clock slave for the receiving port P.

The described means for clock synchronization can be used correspondingly to synchronize equidistance timers in the network subscribers. The purpose of equidistance timers is to enable a plurality or all of the network subscribers to execute predefined actions equidistantly. In control systems, this function is frequently referred to as “electronic wave.” In all of the network subscribers that are interconnected via the network, a clock generator is to be produced, at the clock pulse of which setpoint values are transmitted and actual values queried. An example is the measurement of the electrical power output if the measured current and voltage values that are required for this purpose are detected by separate transducers and are queried via a network.

A prerequisite is that an equidistant cycle is controlled by only one equidistance master. The network subscriber that assumes the function of equidistance master is provided with a timer, which when started is loaded with the parameterizable value of the equidistance interval. The timer is free-running and is decremented with each bit timing. When the timer has expired it is reloaded with the parameterized value of the equidistance interval and a new cycle begins. The difference between an equidistance timer and a clock is thus the running direction. To correct a timer status transmitted with messages, the time delays must therefore not be added, as for the clock time, but subtracted. The term clock synchronization used above should thus be understood to include the synchronization of equidistance timers as well.

For a synchronization of equidistant actions, the following means are available, for instance:

1. The equidistance master enters the equidistance message into the job list. It stores the value of the respective equidistance timer when the last nibble of the type field of the equidistance message has been transferred to the MII of the four ports P, P=1, 2, 3, 4, i.e. for physical transmission. This value Δt_{Equi}, which is stored for each port P and which corresponds to the remaining time until expiration of the equidistance interval, is transmitted to the neighboring network subscribers with the equidistance message via port P.

2. Each network subscriber, after having received the last nibble of the type field of the equidistance message at the MII of a port, i.e. upon receipt of the equidistance message from the physical transmission line, starts an auxiliary timer with the value of the runtime Δt_{DLZP}.

3. At the instant when the neighboring network subscriber applies the last nibble of the type field of the equidistance message to be forwarded to the MII of another port, the value of the auxiliary timer is stored. The stored value of the auxiliary timer corresponds to the transmit time Δtᵢ of this network subscriber for port P. This stored time Δtᵢ is subtracted from the received residual time Δt_{Equi} until the start of the next cycle. The neighboring network subscriber forwards the corrected residual time Δt_{Equi}−Δtᵢ) with the equidistance message via the other port to the next neighboring network subscriber. In addition, it loads the corrected residual time into its equidistance timer, which is decremented with each clock pulse.

4. If the equidistance timer of an equidistance slave expires, it is first loaded with the parameterized value of the equidistance interval and decremented with each bit timing. As soon as a new equidistance message is received from the equidistance master, the equidistance slave loads the residual time (Δt_{Equi}−Δtᵢ) remaining until the start of the next cycle, which is determined in the described manner, into the equidistance timer.

For the described synchronization of equidistance timers, the maximum transmit time between a transmitter and a receiver in the network should be smaller than the length of the equidistance interval.

By means of the exemplary embodiment, a network according to the Ethernet specification was described. The invention, however, is readily applicable to Fast Ethernet, Gigabit Ethernet or other network types as well.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A network having redundancy features, comprising:
a plurality of network subscribers having ports and forming at least a first series and a second series of network subscribers; and
at least a first communication channel and a second communication channel interconnecting the first series and the second series of network subscribers;
wherein the first communication channel is in an active state and the second communication channel is initially in an inactive state;
wherein the first communication channel is formed by a connection between a respective port of a first network subscriber of the plurality of network subscribers and a respective port of a second network subscriber of the plurality of network subscribers, wherein the first network subscriber is arranged in the first series of network subscribers, and wherein the second network subscriber is arranged in the second series of network subscribers;
wherein the second communication channel is formed by a connection between a respective port of a third network subscriber and a respective port of a fourth network subscriber, wherein the third network subscriber is arranged in the first series of network subscribers, and wherein the fourth network subscriber is arranged in the second series of network subscribers;
wherein, if the first communication channel is not interrupted, the first network subscriber is configured to cyclically transmit port-select-messages to other network subscribers of the plurality of network subscribers that are arranged in the first series of network subscribers;
wherein the third network subscriber is configured to evaluate the port-select-messages to monitor the first communication channel for interruption; and
wherein, if the first communication channel is interrupted, the third network subscriber is configured to switch the second communication channel from the inactive state to the active state.

2. The network as claimed in claim 1, wherein the network is configured to satisfy an Ethernet specification and wherein the plurality of network subscribers comprise at least one of sensors and actuators.

3. The network as claimed in claim 1, wherein the plurality of network subscribers are configured to switch that communication channel of the first and second communication channels into the active state that is formed by a connection between i) a respective port of that network subscriber of the first series that is arranged at the shortest distance from a center of the fist series and ii) a respective port of a network subscriber of the second series.

4. The network as claimed in claim 1, further comprising:
a third series of network subscribers;
a third communication channel connecting the first series of network subscribers with the third series of network subscribers; and
a communication path configured to connect at least one of directly and indirectly the second series of network subscribers with the third series;
wherein the communication path does not lead through network subscribers of the first series, so that, if all communication channels of the network are in the active state, a loop is created; and
wherein the plurality of network subscribers are configured to exchange configuration messages so as to ensure that the network is loop-free and that each network subscriber is connected with every other network subscriber via exactly one active communication path.

5. The network as claimed in claim 4,
wherein the plurality of network subscribers are configured to employ a spanning tree method so as to render the network loop-free;
wherein each of the first, second, and third series constitutes a virtual network subscriber in form of a virtual switch; and
wherein each available port of a respective network subscriber of one of the first, second, and third series, whose connection with an available port of a network subscriber of another one of the first, second, and third series forms an available communication channel, constitutes an available port of the virtual switch.

6. The network as claimed in claim 5 further comprising a redundancy manager connected to the two line ends of a respective one of the first, second, and third series;
wherein the redundancy manager is configured to disconnect the two line ends of the respective one of the first, second and third series, if there is no interruption in the respective series; and
wherein the redundancy manager is configured to connect the two line ends of the respective one of the first, second and third series, if there is an interruption in the respective series.

7. The network as claimed in claim 2,
wherein each network subscriber of the plurality of network subscribers comprises:
at least four ports, to which additional network components are connected;
a network-subscriber-internal processor bus;
a microprocessor interface configured to connect the at least four ports with the network-subscriber-internal processor bus;
a switch control configure to route messages between the at least four ports and the microprocessor interface;
a device for redundancy control configured to monitor the first communication channel, which in the active state, for interruption, and, if the first communication channel is interrupted, to switch the second communication channel from the inactive state to the active state.

8. The network as claimed in claim 7, wherein the at least four ports are configured to satisfy at least one of an Ethernet, Fast Ethernet, and Gigabit Ethernet specification.

9. The network as claimed in claim 8, wherein the switch control is configured to evaluate a transmission priority of the messages to be transmitted and that messages with a higher priority are transmitted before messages with a lower priority.

10. The network as claimed in claim 7, wherein each network subscriber further comprises an internal clock and a microprocessor configured to correct the internal clock by means of clock time information received in the messages.

11. A network subscriber of an automation system, comprising:
a plurality of ports, to which additional network components are connected;
a network-subscriber-internal processor bus;
a microprocessor interface configured to connect the plurality of ports with the network-subscriber-internal processor bus;
a switch control configured to route messages between the plurality of ports and the microprocessor interface.

12. The network subscriber as claimed in claim 11, wherein the network subscriber comprises at least one of a sensor and an actuator, and wherein the network subscriber is configured to satisfy an Ethernet specification.

13. The network subscriber as claimed in claim 11, wherein the network subscriber comprises at least four ports.

14. The network subscriber as claimed in claim 11, wherein the network subscriber is configured to satisfy at least one of an Ethernet, Fast Ethernet and Gigabit Ethernet specification.

15. The network subscriber as claimed in claim 14, wherein the switch control is configured to evaluate a transmission priority of the messages to be transmitted and that messages with a higher priority are transmitted before messages with a lower priority.

16. The network subscriber as claimed in claim 11, further comprising an internal clock and a microprocessor configured to correct the internal clock by means of clock time information received in the messages.

17. A network, comprising:
a plurality of field devices configured as a plurality of network subscribers, wherein the network subscribers are interconnected in a linear network topology, and wherein each network subscriber comprises:
a plurality of ports, to which additional network components are connected;
a network-subscriber-internal processor bus;
a microprocessor interface configured to connect the plurality of ports with the network-subscriber-internal processor bus;
a switch control configured to route messages between the plurality of ports and the microprocessor interface.

18. The network as claimed in claim 17, wherein each network subscriber at least one of a sensor and an actuator.

19. The network as claimed in claim 17, further comprising a redundancy manager connected to two line ends of the linear network topology;
wherein the redundancy manager is configured to disconnect the two line ends, if there is no interruption in the in the linear network topology; and
wherein the redundancy manager is configured to connect the two line ends, if there is an interruption in the linear network topology.

20. The network as claimed in claim 17,
wherein the plurality of network subscribers is configured to form at least a first series and a second series of network subscribers; and
wherein at least a first communication channel and a second communication channel interconnect the first series and the second series of network subscribers;
wherein the first communication channel is in an active state and the second communication channel is initially in an inactive state;
wherein the first communication channel is formed by a connection between a respective port of a first network subscriber of the plurality of network subscribers and a respective port of a second network subscriber of the plurality of network subscribers, wherein the first network subscriber is arranged in the first series of network subscribers, and wherein the second network subscriber is arranged in the second series of network subscribers;
wherein the second communication channel is formed by a connection between a respective port of a third network subscriber and a respective port of a fourth network subscriber, wherein the third network subscriber is arranged in the first series of network subscribers, and wherein the fourth network subscriber is arranged in the second series of network subscribers;
wherein the third network subscriber is configured to monitor the first communication channel for interruption; and
wherein, if the first communication channel is interrupted, the third network subscriber is configured to switch the second communication channel from the inactive state to the active state.

21. The network as claimed in claim 20,
wherein, if the first communication channel is not interrupted, the first network subscriber is configured to cyclically transmit port-select-messages to other network subscribers of the plurality of network subscribers that are arranged in the first series of network subscribers; and
wherein the third network subscriber is configured to evaluate the port-select-messages to monitor the first communication channel for interruption.

22. The network as claimed in claim 20, wherein the plurality of network subscribers are configured to switch that communication channel of the first and second communication channels into the active state that is formed by a connection between i) a respective port of that network subscriber of the first series that is arranged at the shortest distance from a center of the fist series and ii) a respective port of a network subscriber of the second series.

23. The network as claimed in claim 20, further comprising:
a third series of network subscribers;
a third communication channel connecting the first series of network subscribers with the third series of network subscribers; and
a communication path configured to connect at least one of directly and indirectly the second series of network subscribers with the third series;
wherein the communication path does not lead through network subscribers of the first series, so that, if all communication channels of the network are in the active state, a loop is created; and
wherein the plurality of network subscribers are configured to exchange configuration messages so as to ensure that the network is loop-free and that each network subscriber is connected with every other network subscriber via exactly one active communication path.

24. The network as claimed in claim 23,
wherein the plurality of network subscribers are configured to employ a spanning tree method so as to render the network loop-free;
wherein each of the first, second, and third series constitutes a virtual network subscriber in form of a virtual switch; and
wherein each available port of a respective network subscriber of one of the first, second, and third series, whose connection with an available port of a network subscriber of another one of the first, second, and third series forms an available communication channel, constitutes an available port of the virtual switch.

25. The network as claimed in claim 17,
wherein a first network subscriber of the plurality of network subscribers is configured to send to a second network subscriber of the plurality of network subscribers a first clock synchronization message, which contains a time that represents a clock time of the first network subscriber corrected by a transmit time delay;
wherein the second network subscriber is configured to store a runtime of the first clock synchronization message over a physical transmission link between the first network subscriber and the second network subscriber; and
wherein the second network subscriber is configured to measure a receive time delay since the receipt of the first clock synchronization message and to correct the time received in the first clock synchronization message by the runtime and the receive time delay.

26. The network as claimed in claim 25, wherein the second network subscriber is configured to transmit to a third network subscriber of the plurality of network subscribers a second clock synchronization message, which contains the time corrected by the runtime and a delay time between receipt of the first clock synchronization message and transmission of the second clock synchronization message.

27. The network as claimed in claim 17,
wherein a first network subscriber of the plurality of network subscribers is configured to send a first clock synchronization message to a second network subscriber of the plurality of network subscribers and to store a time that represents a clock time of the first network subscriber corrected by a transmit time delay of the first clock synchronization message;
wherein the second network subscriber is configured to store a runtime of the first clock synchronization message over a physical transmission link between the first network subscriber and the second network subscriber;
wherein the second network subscriber is configured to measure a receive time delay since receipt of the first clock synchronization message;
wherein the first network subscriber is further configured to send a second message, which contains the time that represents the clock time of the first network subscriber corrected by the transmit time delay, to the second network subscriber; and
wherein the second network subscriber is further configured to correct the time received in the second message by the runtime and the receive time delay.

28. The network as claimed in claim 27, wherein the second network subscriber is further configured to forward the first clock synchronization message to a third network subscriber of the plurality of network subscribers, to measure a delay time of forwarding the first clock synchronization message, and to send a third message to the third network subscriber, which contains a received clock time corrected by the runtime and the delay time of forwarding of the first clock synchronization message to the third network subscriber.

29. The network as claimed in claims 25,
wherein the first network subscriber comprises has a first timer to determine the transmit time delay;
wherein the first network subscriber is configured to start the first timer when a message is entered into a list of transmit jobs;
wherein, after providing the message for physical transmission, the first network subscriber is configured to read the first timer as the transmit time delay by which the clock time, at which the message was entered into the list of the transmit jobs, must be corrected.

30. The network as claimed in claim 29,
wherein the second network subscriber has a second timer for determining the receive time delay; and
wherein the second network subscriber is configured to start the second timer upon receipt of the first clock synchronization message from the physical transmission link.

31. The network as claimed in claim 30, wherein the runtime of the first clock synchronization message over the physical transmission link between the first network subscriber and the second network subscriber is stored as a start value in the second timer before the second timer is started.

32. The network as claimed in claims 25,
wherein the first and the second network subscriber comprise a first and a second media independent interface, respectively; and
wherein a start and an end of the runtime of the first clock synchronization message are determined as instants at which a characteristic field of the first clock synchronization message having a fixed distance from a beginning of the first clock synchronization message leaves the first media independent interface of the first network subscriber and arrives at the second media independent interface of the second network subscriber, respectively.

33. The network as claimed in claim 32, wherein the network is configured to satisfy at least one of an Ethernet, Fast Ethernet or Gigabit Ethernet specification, and wherein the characteristic field of the first clock synchronization message is a type-field.

34. The network as claimed in claim 25,
wherein the first network subscriber is configured to send a first message for runtime determination to a neighboring network subscriber after being added to the network and to start a response timer after providing the first message for physical transmission;
wherein the second network subscriber is configured to start a timer for determining a residence time t_{DA} after receiving the first message for the runtime determination from the physical transmission link;
wherein the second network subscriber is configured to stop the timer after providing a second message for physical transmission and to transmit the measured residence time t_{DA} in a second message for runtime determination to the first network subscriber; and
wherein the first network subscriber is configured to stop the response timer after receiving the second message for runtime determination from the physical transmission link; to evaluate a measured response time t_{DR} and the measured residence time t_{DA} of the second network subscriber; and to determine a runtime t_{DLZ} as
$${t}_{DLZ} = \frac{( {t}_{DR} - {t}_{DA} )}{2} .$$
